(19) United States
(12) Patent Application Publication
(10) Pub. No.: US 2013/0335795 A1
(43) Pub. Date: Dec. 19, 2013

(54) SPATIAL LIGHT MODULATOR AND HOLOGRAPHIC 3D IMAGE DISPLAY INCLUDING THE SAME

(71) Applicant: Samsung Electronics Co., Ltd., Suwon-si (KR)

(72) Inventors: Hoon SONG, Yongin-si (KR); Hong-seok LEE, Seongnam-si (KR); Gee-young SUNG, Daegu (KR); Kang-hee WON, Seoul (KR); Kyu-hwan CHOI, Yongin-si (KR)

(21) Appl. No.: 13/912,259

(22) Filed: Jun. 7, 2013

(30) Foreign Application Priority Data
Jun. 13, 2012 (KR) 10-2012-0063403

(51) Int. Cl. G03H 1/22; G02F 1/01

(52) U.S. Cl. CPC G03H 1/2294; G02F 1/01
USPC 359/9; 359/238; 359/276; 359/279

(57) ABSTRACT

Provided is a complex spatial light modulator and a holographic 3D image display including the complex spatial light modulator. The complex spatial light modulator includes a spatial light modulator for modulating a phase or an amplitude of light, a pair of lens arrays, and a grating disposed between the pair of lens arrays. Accordingly, the phase and the amplitude of light may be modulated simultaneously.

### CROSS-REFERENCE TO RELATED APPLICATIONS

This application claims the benefit under 35 USC §119(a) of Korean Patent Application No. 10-2012-0063403, filed on Jun. 13, 2012, in the Korean Intellectual Property Office, the entire disclosure of which is incorporated herein by reference for all purposes.

### BACKGROUND

1. Field

The following description relates to spatial light modulators and holographic three-dimensional (3D) image display devices including the same.

2. Description of the Related Art

Recently, there has been an increased amount of research into 3D image display devices. A 3D image display device may display 3D images based on binocular parallax. For example, 3D image display devices that have been commercialized recently use a binocular parallax which provides a left eye and a right eye of a viewer with left eye images and right eye images that have different viewpoints from each other to allow the viewer to experience a stereoscopic feel or effect. Typically, these 3D image display devices are classified as glasses-type 3D image display devices which require special glasses and non-glasses type 3D image display devices which do not require special glasses.

However, when viewing 3D images that are displayed based on the binocular parallax, the viewer may experience fatigue or soreness. In addition, the 3D image display device providing the left eye images and the right eye images from only two viewpoints may not reflect variations in the viewpoint based on movements of the viewer, and thus, there is a limitation in providing a natural stereoscopic effect.

In order to display natural 3D images, a holographic 3D image display is being researched. However, if images are displayed using a device that is capable of controlling only one of brightness (amplitude) or phase of an image, image quality may be degraded due to various factors such as 0-th diffracted light, twin images, and speckling.

### SUMMARY

In an aspect, there is provided a complex spatial light modulator including a spatial light modulator for modulating a phase or an amplitude of light, a first lens array to receive light emitted from the spatial light modulator, a grating for diffracting light transmitted through the first lens array, and a second lens array for transmitting the light diffracted by the grating.

The grating may be located at a focal length of the first lens array.

A focal length of the first lens array and a focal length of the second lens array may be equal to each other.

The first lens array may comprise a focal length that is an integer times longer than a focal length of the second lens array.

A lens surface of the first lens array may face the spatial light modulator.

The first lens array may comprises a plurality of lens cells, and each lens cell may comprise a width that is the same as a pitch of n pixels (where n is a natural number).

Each of the plurality of lens cells in the first lens array may face the n pixels of the spatial light modulator in a longitudinal-sectional direction of the first lens array.

The complex spatial light spatial light modulator may comprise an optical electrical device that has a refractive index that changes according to an input electric signal.

The second lens array may comprise a plurality of lens cells, and a black matrix may be disposed between neighboring lens cells.

The complex spatial light modulator may further comprise a phase plate and a polarizing plate which are disposed between the spatial light modulator and the first lens array.

The grating may comprise a pitch such that light emitted from a center of each pixel of the spatial light modulator proceeds in parallel with an optical axis.

In an aspect, there is provided a complex spatial light modulator including a first lens array, a spatial light modulator for modulating a phase of light transmitted through the first lens array, a grating for diffracting the light transmitted through the spatial light modulator, and a second lens array transmitting the light diffracted by the grating.

The grating may be located at a focal length of the first lens array.

A focal length of the first lens array and a focal length of the second lens array may be equal to each other.

The first lens array may have a focal length that is an integer times longer than a focal length of the second lens array.

The first lens array may comprise a plurality of lens cells, and each lens cell may comprise a width that is the same as a pitch of a pixel of the spatial light modulator.

The complex spatial light modulator may further comprise a transparent substrate between the spatial light modulator and the grating.

In an aspect, there is provided a holographic three-dimensional (3D) image display including a light source configured to irradiate light, a spatial light modulator configured to modulate a phase or an amplitude of the light irradiated from the light source, an image signal circuit configured to input an image signal to the spatial light modulator, and a light combiner configured to modulate an amplitude of the light emitted from the spatial light modulator, the light combiner comprising a first lens array configured to receive light emitted from the spatial light modulator, a grating to diffract light transmitted through the first lens array, and a second lens array for transmitting the light diffracted by the grating.

The grating may be located at a focal length of the first lens array.

A focal length of the first lens array and a focal length of the second lens array may be equal to each other.

The first lens array may comprise a focal length that is an integer times longer than a focal length of the second lens array.

A lens surface of the first lens array may face the spatial light modulator.

The first lens array may comprise a plurality of lens cells, and each lens cell may comprise a width that is the same as a pitch of a pixel of the spatial light modulator.

In an aspect, there is provided a modulator for an image display device, the modulator including a spatial light modulator (SLM) configured to modulate a phase of light beams to generate phase-modulated light beams, and a light combiner configured to receive the phase-modulated beams emitted from the SLM and to combine optical paths of at least two phase-modulated beams to generate a light-modulated phase-modulated beam.

The beam combiner may comprise a grating to diffract light, a first lens configured to focus light on the grating, and a second lens configured to transmit light diffracted by the grating.

The SLM may be included in the light combiner between the first lens and the grating.

An n-th order light beam (where n is an integer) among diffracted light of a first light beam L1 and an m-th order light beam (where m is an integer) among diffracted light of a second light beam L2 may be combined by the light combiner to generate a third light beam L3 that is a light-modulated phase-modulated beam.

The light combiner may simultaneously combine the at least two phase-modulated beams to generate the light-modulated phase-modulated beam.

Other features and aspects may be apparent from the following detailed description, the drawings, and the claims.

### BRIEF DESCRIPTION OF THE DRAWINGS

FIG. 1 is a diagram illustrating an example of a complex spatial light modulator.

FIG. 2 is a diagram illustrating an example of the complex spatial light modulator of FIG. 1, in which a phase plate and a polarizing plate are further disposed.

FIG. 3 is a diagram illustrating another example of a complex spatial light modulator.

FIG. 4 is a diagram illustrating another example of a complex spatial light modulator.

FIG. 5 is a diagram illustrating an example of a holographic three-dimensional (3D) image display.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

A conventional liquid crystal display (LCD) image display device typically only controls the brightness (amplitude) of a signal. In an effort to control phase of a signal, a display device may use a space light modulator (SLM). However, in the case of a phase SLM, only a phase can be adjusted, and brightness is not controlled. As such, when images are controlled using a device that may control only one of brightness (amplitude) or phase, quality of reproduced images may be degraded due to 0-th diffraction beam, twin images, speckling, and the like. The complex spatial modulator described herein may be applied to existing front panel displays to generate a holographic three-dimensional (3D) image.

To address the above problems, provided herein is a device for controlling a phase and a brightness of light using the same device. According to various aspects, optical paths of light emitted from a SLM may be combined to control amplitude and phase simultaneously using the combined wave.

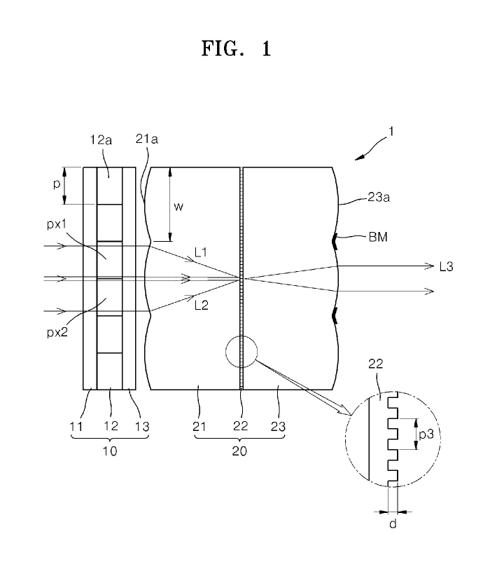

FIG. 1 illustrates an example of a complex spatial light modulator 1. Referring to FIG. 1, the complex spatial light modulator 1 includes a spatial light modulator 10 for modulating a phase or an amplitude of a light beam, and a light combiner 20 for combining light emitted from the spatial light modulator 10. According to various aspects, the complex spatial light modulator 1 may module both the phase and the amplitude of light.

For example, the spatial light modulator 10 may include an optical electrical device that may change a refractive index according to an electric signal. The spatial light modulator 10 may include a photoelectric material layer 12, for example, a liquid crystal layer. In the example of FIG. 1, a first glass substrate 11 and a second glass substrate 13 are disposed on a front portion and a rear portion of the photoelectric material layer 12. Also, a control circuit is formed on the first glass substrate 11.

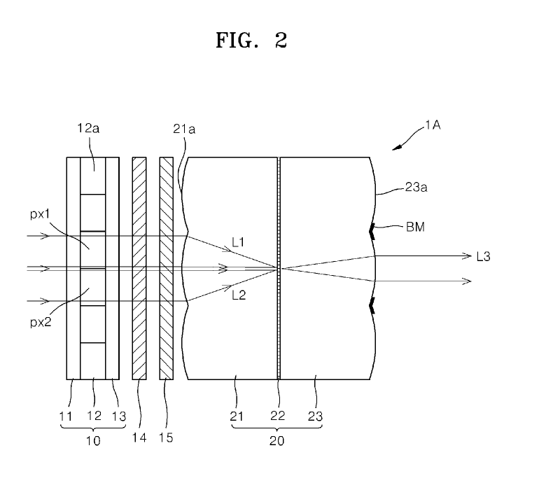

The spatial light modulator 10 may control a phase or an amplitude of emitted light using a refractive index that may be changed when a voltage is applied to the photoelectric material layer 12. However, phase retardation may occur according to characteristics of the photoelectric material layer 12, thereby changing a polarization direction. In order to correct the changed polarization direction, a phase plate 14 and a polarizing plate 15 may be further disposed next to the spatial light modulator 10, as shown in a spatial light modulator 1A of FIG. 2. For example, to modulate phase, the spatial light modulator 10 may be a phase modulator. As another example, to modulate amplitude, the spatial light modulator 10 may be an amplitude spatial light modulator.

The spatial light modulator 10 includes a plurality of pixels 12a. For example, the plurality of pixels 12a may be arranged in a two-dimensional (2D) matrix form.

The light combiner 20 includes a first lens array 21, a grating 22, and a second lens array 23. For example, the first lens array 21 and the second lens array 23 may be a micro lens array and a lenticular lens array, respectively. The first lens array 21 may include a plurality of lens cells 21a, and the second lens array 23 may include a plurality of lens cells 23a. According to various aspects, a focal length f1 of the first lens array 21 and a focal length f2 of the second lens array 23 may be equal to each other. As another example, the focal length f1 of the first lens array 21 and the focal length f2 of the second lens array 23 may be different from each other. In this example, the grating 22 is disposed at the focal length of the first lens array 21. The grating 22 may include a diffractive optical element (DOE) or a holographic optical element (HOE).

Lens surfaces of the first lens array 21 may be arranged to face the spatial light modulator 10, and lens surfaces of the second lens array 23 may be arranged away from the grating 22. However, it should be appreciated that the present description is not limited thereto, that is, the lens surfaces of the first lens array 21 may be arranged away from the spatial light modulator 10.

Each of the lens cells 21a of the first lens array 21 may have a width w that is n-times a pitch p of each of the pixels 12a in the spatial light modulator 10. In this example, the pixel pitch p and the width w of the lens cell 21a may be based on a longitudinal cross section shown in FIG. 1. Each of the lens cells 21a of the first lens array 21 may correspond to two pixels 12a of the spatial light modulator 10. In addition, the lens cells 21a of the first lens array 21 may be arranged to correspond to the lens cells 23a of the second lens array 23.

Examples of the operations of the complex spatial light modulator 1 of FIG. 1 are described herein. For example, when light is incident on the spatial light modulator 10, the light may be focused on the grating 22 via the first lens array 21. Here, a phase or an amplitude of the light may be modulated by the pixels 12a of the spatial light modulator 10. The focused light may be diffracted by the grating 22. The grating 22 may include, for example, a plurality of grooves 22a that are arranged with predetermined pitch intervals p3. A diffraction angle of the diffracted light may be adjusted according to a pitch interval p3 of the grating 22. In addition, a diffraction efficiency may be adjusted by adjusting a depth d of the plurality of grooves 22a.

For example, in a design of a prim, the pitch of the prism may be approximately 150 μm and a pitch of the grating may have a pitch in a range of 10.5-11.5 μm, when the prim has a prism angle in a range of 0-7 degrees and an out prism angle is in a range of 0-3 degrees.

For example, a first pixel px1 and a second pixel px2 of the spatial light modulator 10 may correspond to one of the lens cells 21a of the first lens array 21. In this example, a first light beam L1, a phase of which may be modulated by the first pixel px1, and a second light beam L2, a phase of which may be modulated by the second pixel px2, may both be incident on the same corresponding cell 21a of the first lens array 21. The first light beam L1 and the second light beam L2 may be focused on the grating 22 by the first lens array 21. In addition, the first and second light beams L1 and L2 may be diffracted by the grating 22. Diffraction angles of the first and second light beams L1 and L2 may be adjusted according to the interval of the pitches of the grating 22. The first and second light beams L1 and L2 may be respectively diffracted via the grating 22.

According to various aspects, n-th order light (where n is an integer) among the diffracted light of the first light beam L1 and m-th order light (where m is an integer) among the diffracted light of the second light beam L2 may be combined. For example, −1st order light of the first light beam L1 may proceed along an optical axis of the grating 22 and +1st order light of the second light beam L2 may proceed along the optical axis of the grating 22. Accordingly, the −1st order diffracted light of the first light beam L1 and the +1st order diffracted light of the second light beam L2 may be combined. For example, the pitch interval p3 of the grating 22 may be determined so that the light emitted from a center of the pixel may proceed in parallel with the optical axis. For example, the pitch interval p3 of the grating 22 may be adjusted according to equation 1 below so that the 1st order diffracted light of the first light beam L1 and the second light beam L2 may proceed along the optical axis.

p3=λ×f1/p [Equation 1]

In Equation 1, λ denotes a wavelength of light, f1 denotes a focal length of the first lens array 21, and p denotes a pitch of the pixels.

Here, +1st order light and −1st order light are examples, and the pitch interval of the grating 22 may be adjusted so as to control n-th order light (where n is an integer) to proceed in the optical axis direction of the grating 22. In addition, the depth d of the grating 22 may be adjusted to control a diffraction efficiency of the diffracted light proceeding in the optical axis direction. For example, a third light beam L3 which is a combination of the −1st order light and the +1st order light proceeding along the optical axis may be transmitted through the second lens array 23. As described above, an amplitude of the third light beam L3 may be controlled by combining the diffracted light. For example, the third light beam L3 may become a plane wave while being transmitted through the second lens array 23.

In some examples, a black matrix BM may be further disposed between two neighboring lens cells 23a of the second lens array 23. As such, image quality degradation caused by diffraction or dispersion occurring at a boundary between the lens cells 23a of the second lens array 23 may be prevented.

As described above, a phase or an amplitude of the light is modulated by the spatial light modulator 10, and the light combiner 20 may combine the light.

For example, if the initial first light beam and the second light beam have the same amplitudes as each other and have a phase φ1 and φ2 respectively, wave equations of the first and second light beams are as follows.

First light beam=exp(i*φ1), second light beam=exp(i*φ2) [Equation 2]

In addition, a wave equation of the combined light transmitted through the light combiner 20 is as follows.

First light beam+second light beam=exp(i*φ1)+exp(i*φ2) [Equation 3]

The above equation (2) may be simplified as follows.

First light beam+second light beam=cos [(φ1−φ2)/2]exp[(φ1+φ2)/2] [Equation 4]

Here, ‘cos’ is in regard to the amplitude, and ‘exp’ is in regard to the phase. The amplitude and the phase of the combined light may be determined according to the amplitudes and the phases of the light beams incident on the light combiner 20.

According to various aspects, the phase and the amplitude of light may be modulated together, and thus, image quality degradation due to twin images or speckles may be prevented. In addition, because the spatial light modulator 10 and the light combiner 20 are arranged in parallel with each other, optical arrangement may be easily performed. Furthermore, a slim type spatial light modulator 10 and the light combiner 20 may be manufactured and arranged, thereby slimming the complex spatial light modulator 1. Therefore, the slimmed complex spatial light modulator 1 may be applied to, for example, a flat panel display (FPD).

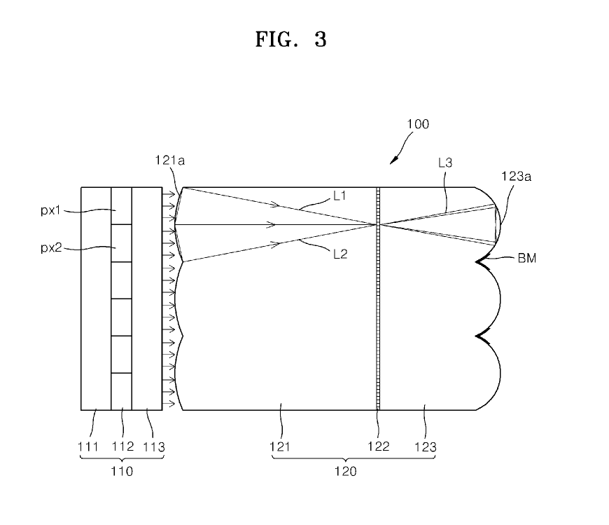

FIG. 3 illustrates another example of a complex spatial light modulator 100. Referring to FIG. 3, the complex spatial light modulator 100 includes a spatial light modulator 110 for modulating a phase or an amplitude of light and a light combiner 120 for combining light emitted from the spatial light modulator 110.

The spatial light modulator 110 has substantially the same structure and operations as those of the spatial light modulator 10 described with reference to FIG. 1.

The light combiner 120 may include a first lens array 121, a grating 122, and a second lens array 123. The first lens array 121 may include a plurality of lens cells 121a, and the second lens array 123 may include a plurality of lens cells 123a. In this example, a focal length f1 of the first lens array 121 and a focal length f2 of the second lens array 123 are different from each other. For example, the focal length f1 of the first lens array 121 may be an integer (i.e. 2×, 3×, 4×) times longer than the focal length f2 of the second lens array 123. In addition, the grating 122 may be disposed within the focal length f1 of the first lens array 121.

A first pixel px1 and a second pixel px2 of the spatial light modulator 110 may correspond to one of the lens cells 121a of the first lens array 121. For example, a first light beam L1, a phase or an amplitude of which may be modulated by the first pixel px1, and a second light beam L2, a phase or an amplitude of which may be modulated by the second pixel px2, may both be incident on the same corresponding cell 121a of the first lens array 121. The first and second light beams L1 and L2 may be focused on the grating 122 by the first lens array 121. For example, each of the first and second light beams L1 and L2 may be diffracted in various orders by the grating 122.

Here, when the focal length f1 of the first lens array 121 is an integer times longer than the focal length f2 of the second lens array 123, a first diffracted light beam of the first light beam L1 and a second diffracted light beam of the second light beam L2 may be combined with each other, and a third diffracted light beam of the first light beam L1 and a fourth diffracted light beam of the second light beam L2 may be combined with each other.

Diffraction angles of the first and second light beams L1 and L2 may be adjusted according to an interval between pitches of the grating 122. For example, when the focal length f1 of the first lens array 121 is twice as long as the focal length f2 of the second lens array 123, 0-th order light of the first light beam L1 and 1st order light of the second light beam L2 may be combined and 1st order light of the first light beam L1 and 0th order light of the second light beam L2 may be combined. Otherwise, efficiency of combined light L3 may be improved by combining three or more order light beams. It should be appreciated that the diffraction order of the diffracted light is not limited thereto, and may be variously modified according to the focal lengths of the first lens array 121 and the second lens array 123, and the design of the grating 122. For example, the focal length f1 of the first lens array 121 may be three times longer or more than the focal length f2 of the second lens array 123. Also, in the example of FIG. 3, the focal length of the first lens array 121 is longer than that of the second lens array 123, however, in some examples the focal length of the first lens array 121 may be shorter than that of the second lens array 123. In some examples, a black matrix BM may be further disposed between two neighboring lens cells 123a of the second lens array 123.

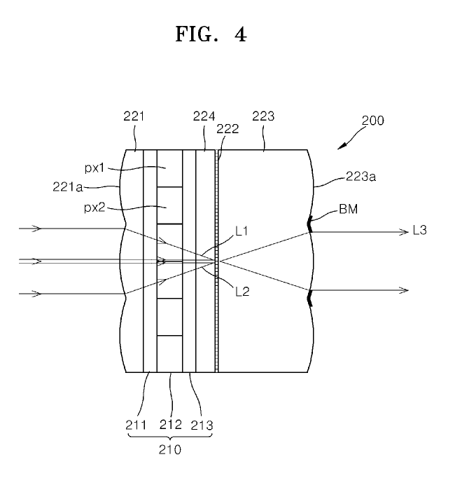

FIG. 4 illustrates another example of a complex spatial light modulator 200. Referring to FIG. 4, the complex spatial light modulator 200 includes a spatial light modulator 210 for phase modulation and a light combiner 220 for combining the light emitted from the spatial light modulator 210.

The spatial light modulator 210 has substantially the same structure and operations as those of the spatial light modulator 10 described with reference to FIG. 1.

The light combiner 220 includes a first lens array 221, a grating 222, and a second lens array 223. The first lens array 221 may include a plurality of lens cells 221a, and the second lens array 223 may include a plurality of lens cells 223a. A focal length f1 of the first lens array 221 and a focal length f2 of the second lens array 223 may be the same as or may be different from each other. In the example of FIG. 4 the focal length f1 of the first lens array 221 and the focal length f2 of the second lens array 223 are equal to each other, but the example is not limited thereto. For example, the focal length f1 of the first lens array 221 may be an integer times longer than the focal length f2 of the second lens array 223. In addition, the grating 222 may be disposed within the focal length f1 of the first lens array 221.

In this example, the spatial light modulator 210 is disposed between the first lens array 221 and the grating 222. In this example, image quality degradation due to diffraction or scattering of the light occurring at a boundary between the lens cells of the first lens array 221 may be prevented. Furthermore, a transparent substrate 224 is further disposed between the spatial light modulator 210 and the grating 222. For example, a rough portion may be disposed at the boundary between the lens cells, and the light may be scattered or diffracted when passing through the rough portion. When the spatial light modulator 210 is disposed between the first lens array 221 and the grating 222, the scattering or the diffraction of light may be reduced.

On the other hand, n (where n is a natural number) pixels, of the spatial light modulator 210 may correspond to one of the lens cells 221a of the first lens array 221. For example, two pixels, that is, a first pixel px1 and a second pixel px2 of the spatial light modulator 210 may correspond to one of the lens cells 221a of the first lens array 221. In addition, a first light beam L1, a phase or an amplitude of which may be modulated by the first pixel px1, and a second light beam L2, a phase or an amplitude of which may be modulated by the second pixel px2, may be focused on the grating 222. The light may be incident on the spatial light modulator 210 at a predetermined incident angle through the first lens array 221, and may be focused on the grating 222 after being transmitted through the spatial light modulator 210.

In addition, the first and second light beams L1 and L2 may be simultaneously diffracted by the grating 222 to generate a combined light beam. A combined light beam L3 of n-th order diffracted light (n is an integer) of the first light beam L1 and m-th order diffracted light of the second light beam L2 may be emitted through the second lens array 223. For example, −1st order diffracted light of the first light beam L1 and +1st order diffracted light of the second light beam L2 may be combined. In some examples, a black matrix BM may be further disposed between two neighboring lens cells 223a of the second lens array 223.

According to various aspects, the complex spatial light modulator may modulate both the phase and the amplitude of the light together by modulating the phase of light using the spatial light modulator and modulating the amplitude of light using the light combiner. Accordingly, the phase and the amplitude of light may be modulated simultaneously, and thus, image quality degradation due to twin images or speckles may be prevented. According to various aspects, the complex spatial light modulator may be included in a holographic 3D image display for displaying 3D holographic images.

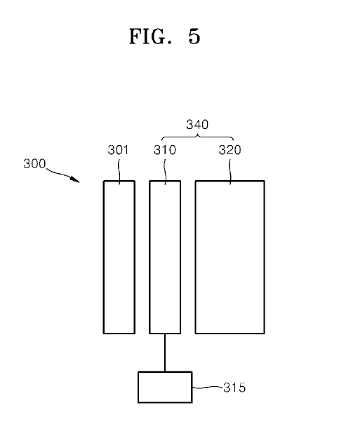

FIG. 5 illustrates an example of a holographic 3D image display 300.

Referring to FIG. 5, the holographic 3D image display 300 includes a light source unit 301 for irradiating light, and a complex spatial light modulator 340 for displaying 3D images using the light emitted from the light source unit 301. The complex spatial light modulator 340 may include a spatial light modulator 310 for modulating a phase or an amplitude of the light, and a light combiner 320 for combining the light emitted from the spatial light modulator 310. The complex spatial light modulator 340 may further include an image signal circuit unit 315 for inputting holographic image signals to the spatial light modulator 340. For example, the complex spatial light modulator 340 may be the complex spatial light modulator 1, 1A, 100, or 200 described herein with reference to FIGS. 1 through 4.

In this example, because the complex spatial light modulator 340 may adjust the amplitude (brightness) and the phase of light simultaneously, 3D images of high quality may be provided without twin images or speckles. Also, the complex spatial light modulator may be manufactured as a slim type complex spatial light modulator so as to reduce a size of the holographic 3D image display including the complex spatial light modulator. In addition, the complex spatial light modulator may be applied to the holographic 3D image display of a flat type to generate high quality 3D images.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A complex spatial light modulator comprising:
a spatial light modulator for modulating a phase or an amplitude of light;
a first lens array to receive light emitted from the spatial light modulator;
a grating for diffracting light transmitted through the first lens array; and
a second lens array for transmitting the light diffracted by the grating.

2. The complex spatial light modulator of claim 1, wherein the grating is located at a focal length of the first lens array.

3. The complex spatial light modulator of claim 1, wherein a focal length of the first lens array and a focal length of the second lens array are equal to each other.

4. The complex spatial light modulator of claim 1, wherein the first lens array comprises a focal length that is an integer times longer than a focal length of the second lens array.

5. The complex spatial light modulator of claim 1, wherein a lens surface of the first lens array faces the spatial light modulator.

6. The complex spatial light modulator of claim 1, wherein the first lens array comprises a plurality of lens cells, and each lens cell comprises a width that is the same as a pitch of n pixels (where n is a natural number).

7. The complex spatial light modulator of claim 6, wherein each of the plurality of lens cells in the first lens array faces the n pixels of the spatial light modulator in a longitudinal-sectional direction of the first lens array.

8. The complex spatial light modulator of claim 1, wherein the spatial light modulator comprises an optical electrical device that has a refractive index that changes according to an input electric signal.

9. The complex spatial light modulator of claim 1, wherein the second lens array comprises a plurality of lens cells, and a black matrix is disposed between neighboring lens cells.

10. The complex spatial light modulator of claim 1, further comprising a phase plate and a polarizing plate which are disposed between the spatial light modulator and the first lens array.

11. The complex spatial light modulator of claim 1, wherein the grating comprises a pitch such that light emitted from a center of each pixel of the spatial light modulator proceeds in parallel with an optical axis.

12. A complex spatial light modulator comprising:
a first lens array;
a spatial light modulator for modulating a phase of light transmitted through the first lens array;
a grating for diffracting the light transmitted through the spatial light modulator; and
a second lens array transmitting the light diffracted by the grating.

13. The complex spatial light modulator of claim 12, wherein the grating is located at a focal length of the first lens array.

14. The complex spatial light modulator of claim 12, wherein a focal length of the first lens array and a focal length of the second lens array are equal to each other.

15. The complex spatial light modulator of claim 12, wherein the first lens array has a focal length that is an integer times longer than a focal length of the second lens array.

16. The complex spatial light modulator of claim 12, wherein the first lens array comprises a plurality of lens cells, and each lens cell comprises a width that is the same as a pitch of n pixels (where n is a natural number).

17. The complex spatial light modulator of claim 12, further comprising a transparent substrate between the spatial light modulator and the grating.

18. A holographic three-dimensional (3D) image display comprising:
a light source configured to irradiate light;
a spatial light modulator configured to modulate a phase or an amplitude of the light irradiated from the light source;
an image signal circuit configured to input an image signal to the spatial light modulator; and
a light combiner configured to modulate an amplitude of the light emitted from the spatial light modulator, the light combiner comprising a first lens array configured to receive light emitted from the spatial light modulator, a grating to diffract light transmitted through the first lens array, and a second lens array for transmitting the light diffracted by the grating.

19. The holographic 3D image display of claim 18, wherein the grating is located at a focal length of the first lens array.

20. The holographic 3D image display of claim 18, wherein a focal length of the first lens array and a focal length of the second lens array are equal to each other.

21. The holographic 3D image display of claim 18, wherein the first lens array comprises a focal length that is an integer times longer than a focal length of the second lens array.

22. The holographic 3D image display of claim 18, wherein a lens surface of the first lens array faces the spatial light modulator.

23. The holographic 3D image display of claim 18, wherein the first lens array comprises a plurality of lens cells, and each lens cell comprises a width that is the same as a pitch of n pixels (where n is a natural number).

24. A modulator for an image display device, the modulator comprising:
a spatial light modulator (SLM) configured to modulate a phase of light beams to generate phase-modulated light beams; and
a light combiner configured to receive the phase-modulated beams emitted from the SLM and to combine optical paths of at least two phase-modulated beams to generate a light-modulated phase-modulated beam.

25. The modulator of claim 24, wherein the beam combiner comprises a grating to diffract light, a first lens configured to focus light on the grating, and a second lens configured to transmit light diffracted by the grating.

26. The modulator of claim 25, wherein the SLM is included in the light combiner between the first lens and the grating.

27. The modulator of claim 24, wherein an n-th order light beam (where n is an integer) among diffracted light of a first light beam L1 and an m-th order light beam (where m is an integer) among diffracted light of a second light beam L2 are combined by the light combiner to generate a third light beam L3 that is a light-modulated phase-modulated beam.

28. The modulator of claim 24, wherein the light combiner simultaneously combines the at least two phase-modulated beams to generate the light-modulated phase-modulated beam.
